(19) United States
(12) Patent Application Publication
(10) Pub. No.: US 2020/0012004 A1
(43) Pub. Date: Jan. 9, 2020

(54) METHOD AND SYSTEM FOR SEISMIC DATA ACQUISITION WITH FRONT AND TOP SOURCES

(71) Applicant: SERCEL, cARQUEFOU (FR)

(72) Inventors: Thomas ELBOTH, Oslo (NO); Vetle VINJE, Oslo (NO); Honglei SHEN, Oslo (NO)

(21) Appl. No.: 16/028,703

(22) Filed: Jul. 6, 2018

(51) Int. Cl. G01V 1/38

(52) U.S. Cl. CPC G01V 1/3808; G01V 1/3826; G01V 1/3835

(57) ABSTRACT

A seismic data acquisition system includes a streamer spread including plural streamers that extend along an inline direction X; a set of front sources that are positioned ahead of the streamer spread along the inline direction X; and a set of top sources that are positioned on top of the streamer spread, along a horizontal direction that is perpendicular to the inline direction X. A characteristic of the set of front sources is different from a characteristic of the set of top sources, and bins corresponding to collected seismic data from each source set are interleaved.

### TECHNICAL FIELD

Embodiments of the subject matter disclosed herein generally relate to methods and systems for seismic data acquisition with multiple source sets, and more particularly, to mechanisms and techniques for acquiring seismic data with a first source set located in front of a streamer spread and a second source set located on top of the streamer spread.

### BACKGROUND

In oil and gas exploration and exploitation, marine seismic surveys are an important tool for making drilling-related decisions. Seismic data acquired during such a survey is processed to generate a profile, which is a three-dimensional approximation of the geophysical structure under the seafloor. This profile enables those trained in the field to evaluate the presence or absence of oil and/or gas reservoirs, which leads to better management of reservoir exploitation. Enhancing seismic data acquisition and processing is an ongoing process.

FIG. 1 is a vertical-plane view of a generic marine survey setup 100. A vessel 101 tows a seismic source 102 (note that, for simplicity, the source's full configuration is not shown) and streamers (only one streamer 104 is visible in this view) in a towing direction T. When the seismic source is activated, seismic energy is emitted into the water and propagates into the rock formation under the seafloor 110. The seismic energy is partially reflected and partially transmitted at interfaces where the acoustic impedance changes, such as at the seafloor 110 and at an interface 112 inside the rock formation. Reflected energy may be detected by sensors or receivers 106 (e.g., hydrophones, geophones and/or accelerometers) carried by the streamers. The seismic data represents the detected energy.

As illustrated in FIG. 1, conventional marine seismic surveys typically mobilize a single vessel towing typically two airgun source arrays in front of a spread of ten or more streamers. The data acquired in this way are narrow-azimuth and lack near offsets owing to the distance between the sources and the streamers, which can be in the range of 100 to 200 m for the inner cables and up to 500 m for the outer cables of the streamer spread. Several solutions, such as coil shooting or advanced multi-vessel operations have been proposed and deployed to improve azimuth coverage and fold, but these solutions are generally expensive and/or time-consuming, and none of them record zero-offset data. Near- and zero-offset data are, however, especially desired for imaging shallow geological targets and of great benefit for multiple attenuation.

Thus, there is a need to provide data acquisition systems and methods that record both zero-offset data and dual azimuths in an effective and safe way.

### SUMMARY

Methods and systems to acquire both zero offset high-resolution seismic data and conventional mid and long offset data by using plural sources having a large source separation, with at least one source towed above the streamer spread.

According to an embodiment, there is a seismic data acquisition system that includes a streamer spread including plural streamers that extend along an inline direction X; a set of front sources that are positioned ahead of the streamer spread along the inline direction X; and a set of top sources that are positioned on top of the streamer spread, along a horizontal direction that is perpendicular to the inline direction X. A characteristic of the set of front sources is different from a characteristic of the set of top sources, and bins corresponding to collected seismic data from each source set are interleaved.

According to another embodiment, there is a method for determining positions of various components of a seismic survey system. The method includes deploying a streamer spread including plural streamers to extend along an inline direction X; positioning a set of front sources ahead of the streamer spread along the inline direction X; and positioning a set of top sources on top of the streamer spread, along a horizontal direction that is perpendicular to the inline direction X. A characteristic of the set of front sources is different from a characteristic of the set of top sources, and bins corresponding to collected seismic data from each source set are interleaved.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a generic marine survey setup;

FIG. 2 is a top view of a marine survey system having front and top sources;

FIG. 3 is a side view of a marine survey system having front and top source sets;

FIG. 4 is a top view of a marine survey system having front and top source sets having different number of sources;

FIG. 5 is a schematic illustration of a marine survey system having front and top source sets that shot with different shot point intervals;

FIGS. 6A and 6B illustrate a marine survey system having front and top source sets that generate interleaved bins;

FIGS. 7A and 7B illustrate a marine survey system having front and top source sets having different cross-line source line separations;

FIGS. 8A and 8B illustrate the effect of feathering on a marine survey system having front and top source sets;

FIGS. 9A and 9B illustrate the effect of stacking for a marine survey system having front and top source sets;

FIG. 10 illustrates a marine survey system having front and top source sets, where the top source set is positioned ahead of the front source set;

FIG. 11 illustrates seismic data collected with a marine survey system having front and top source sets; and

FIG. 12 is a flow chart of a method for distributing the various elements of a seismic acquisition system having front and top source sets.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a marine seismic data acquisition having a front set of sources and a top set of sources. However, the current inventive concepts may be used for other types of surveys, such as surveys using electromagnetic waves or land surveys.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to various embodiments described in this section, a new acquisition geometry is employed for collecting seismic data and this geometry gives a better sampling of the important near offsets, improves the cross-line sampling, and provides notch diversity for robust processing-based deghosting. This new acquisition geometry uses a split-spread, source-over-cable configuration, with a deep streamer spread slanting upwards in at least one direction.

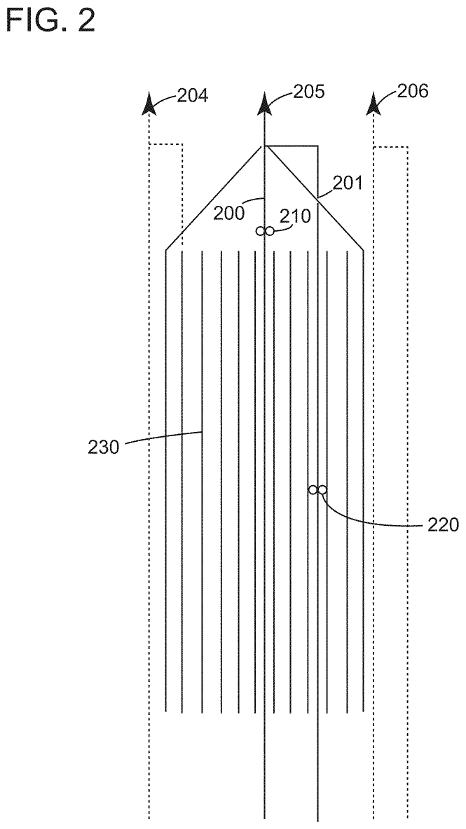

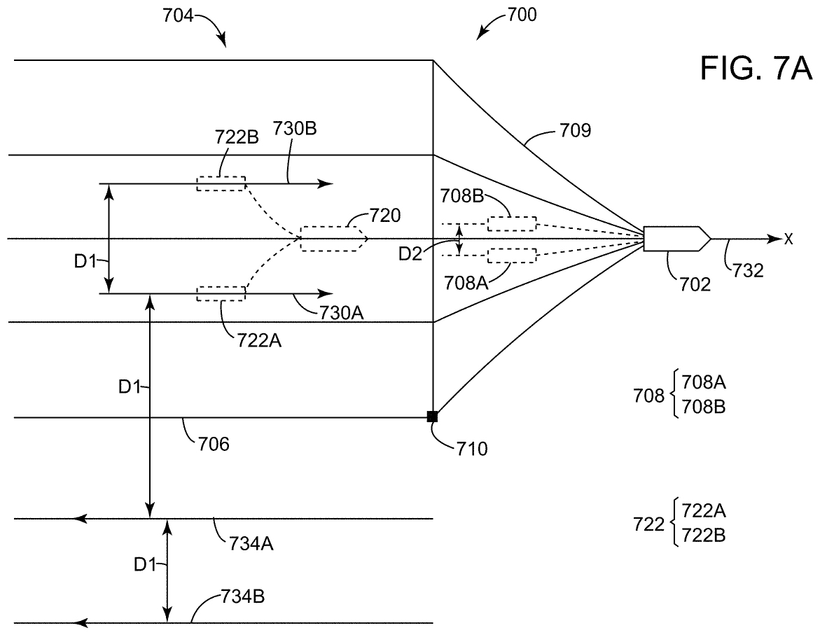

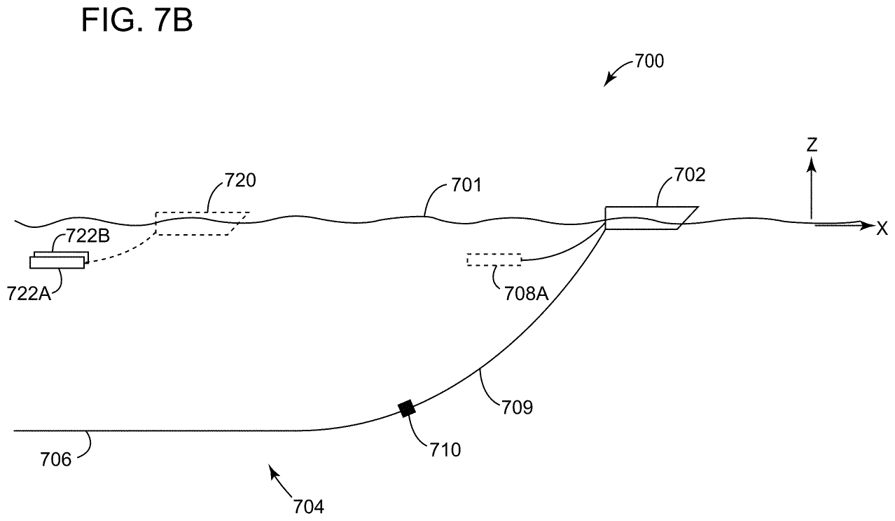

By moving some of the sources so that they are directly over the deep-towed streamers, a much better and denser sampling of the reflected narrow cone of energy from the target is achieved. Such a configuration was introduced by U.S. Patent Application Publication 2017/0017005 (herein “the '005 publication”), assigned to the assignee of this application. This configuration is illustrated in FIG. 2 (it corresponds to the configuration shown in FIG. 7 of the patent application publication noted above) and is capable of recording near- and zero-offset data, which is important to achieve high resolution subsurface imaging and to improve multiple prediction and subtraction.

FIG. 2 illustrates a data acquisition system including dual source sets, with a front set including sources 210 and a top set including sources 220. Sources 220 are towed over the streamer spread 230. The streamer spread 230 includes twelve streamers at 50 m cross-line distance from one another. Source line 200 corresponding to the front source 210 coincides with sail line 205, and is offset along a cross-line direction from source line 201, which corresponds to top source 220. The individual sources of dual sources 210 and 220 are shifted about 12.5 m cross-line relative to the respective source lines 200 and 201.

Source line 200 is substantially in the middle of the streamer spread and about half cross-line distance between the 6th and 7th streamers (counting from left to right). Source line 201 is about half cross-line distance between the 9th and 10th streamers. FIG. 2 also indicates (using dashed lines) the sail lines 204 and 206 and corresponding source lines adjacent to sail line 205, along which the illustrated system sails at various times.

The streamers for such a configuration may have a depth-varying profile while towed. The streamers may be towed at depths between 5 m and 50 m, and the two seismic sources 210 and 220 may be towed at depths between 3 m and 20 m. Beyond specific ranges, the streamers are towed such as to allow towing the top source over them. The sources may be multi-level (i.e., having source elements at different depths, e.g., at 6, 10 and 15 m).

The seismic data acquired with the configuration illustrated in FIG. 2 (also called TopSeis configuration in the art) is in general blended, meaning that reflected energy from two or more sources are recorded simultaneously. Various techniques exist for deblending (separate) this data. However, these techniques work much better if one or more characteristics regarding the TopSeis configuration are selected to have certain values as now discussed.

The present inventors have noted that the '005 publication introduced the TopSeis configuration, but did not address any characteristics related to the number of front and top sources, the shot point interval (SPI, i.e., the interval between firing a source), the cross-line separation for the top sources and the cross-line separation for the front sources. These characteristics have been found to play an important role for deblending and general subsurface imagine qualify of the seismic data and are now discussed.

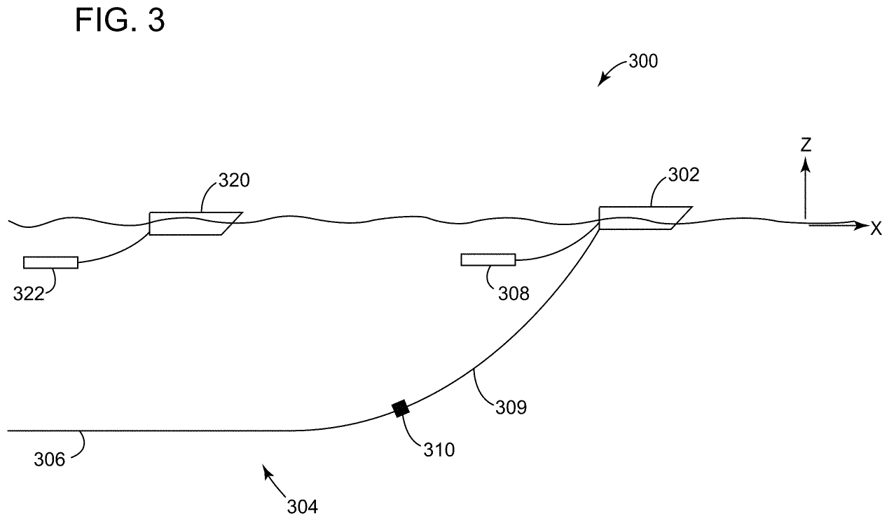

For clarity, a TopSeis configuration 300 is considered herein to include, as illustrated in FIG. 3, a streamer vessel 302 that tows a streamer spread 304, the streamer spread 304 including a given number of streamers 306, and a source vessel 320 that tows plural sources 322 over the streamer spread. These sources are called herein top sources because they are located above (along a vertical direction Z) the streamer spread. The streamer vessel 302 also tows plural sources 309, which are called herein front sources because these sources are located in front (along the inline direction X) of the streamer spread 304. Note that FIG. 3 shows the streamer spread 304 being connected at point 310 to the streamer vessel 302 by tow lines 309, which are not part of the streamer spread. Thus, the front sources 308 are not directly above (along the vertical Z direction) the streamer spread 304. In one embodiment, the streamer vessel 302 may be configured to tow both the front sources 308 and the top sources 322. As discussed above, streamers 306 may be horizontal, slanted or curved.

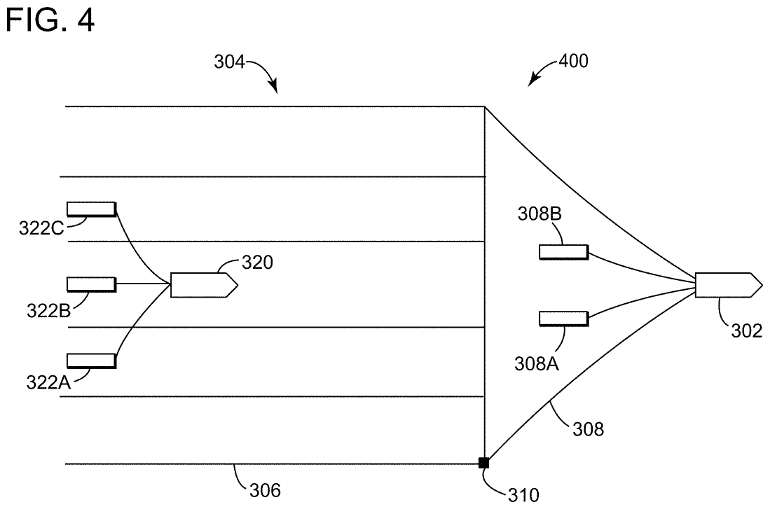

According to an embodiment, a first characteristic of a TopSeis configuration is the number of sources in the front and top sets. In this embodiment, the number of front sources Nf is different from the number of top sources Nt. In this regard, FIG. 4 shows a specific implementation in which the number of front sources Nf=2 and the number of top sources Nt=3. FIG. 4 shows two front sources 308A and 308B and three top sources 322A, 322B, and 322C. A source is defined herein as including an array of source elements, where a source element is a single airgun or a single vibrator. It is customary in the marine acquisition field to have the source elements arranged as two or three subarrays, each subarray having a plurality of source elements. The two or three subarrays together form the source. Thus, the source 308 or 322 in FIG. 3 includes plural source elements, that may be arranged in one, two, three or more subarrays. Each source 308A, 308B, 322A, 322B, and 322C also includes plural source elements, which may be arranged in one, two, three or more subarrays.

With this understanding of a source, subarray, and source element, FIG. 4 shows that the number of sources (not subarrays or source elements) differs for the front and top source sets. Although FIG. 4 shows two vessels towing the two sets of sources, as already discussed above, in one application it is possible to tow all the sources, front and top, with the streamer vessel 302. In another application, it is possible to tow the front sources with the streamer vessel 302 and to have the top sources independently carried by their own carrier, e.g., small boat, autonomous underwater vehicle (AUV), etc.

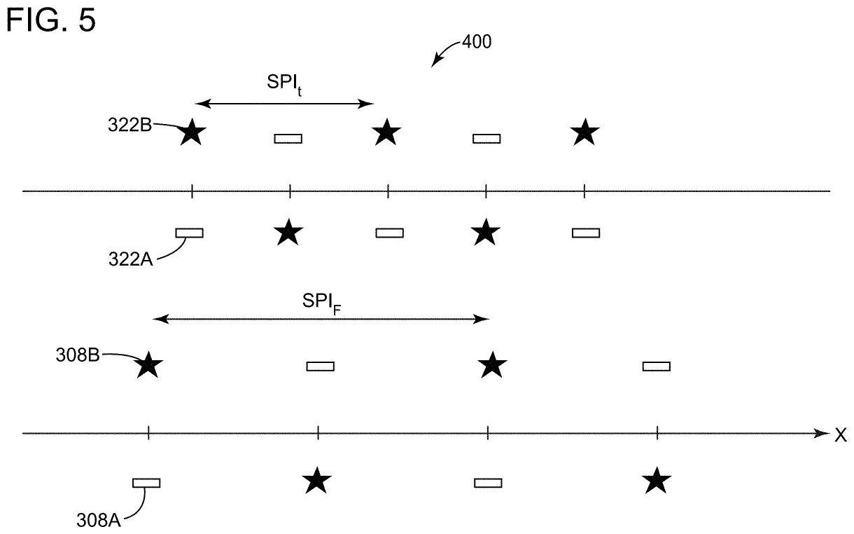

According to another embodiment, a second characteristic of a TopSeis configuration is the SPI of the top and front sources. In this embodiment, the SPI for the front sources (SPIf) and the SPI for the top sources (SPIt) are selected to be different. In one application, the SPIf is not only different from SPIt, but is also not a multiple or a factor of the SPIt. For example, it is possible to have the SPIf=12.5 m and the SPIt=8.33 m. In another example, the SPIf=13.5 m and the SPIt=8.33 m. Using different SPIs for the top and front sources helps in deblending the seismic data, as discussed later. For this embodiment, the number of front sources may be the same or different from the number of top sources. FIG. 5 illustrates two front sources 308A and 308B being towed along the inline direction X and being shot in a flip-flop manner, with a given SPIf. FIG. 5 also illustrates two top sources (not three in this embodiment) 322A and 322B being towed along the same inline direction and being shot in a flip-flop manner, with a SPIt smaller than the SPIf. Other shooting methods may be used to shoot the sources. Irrespective of the method used to shoot the sources and irrespective of the number of front sources and the number of top sources, the SPIf and the SPIt are selected to be different in this embodiment. Those skilled in the art would also understand that in one application, both the number of sources and the SPIs are different for the top and front sources.

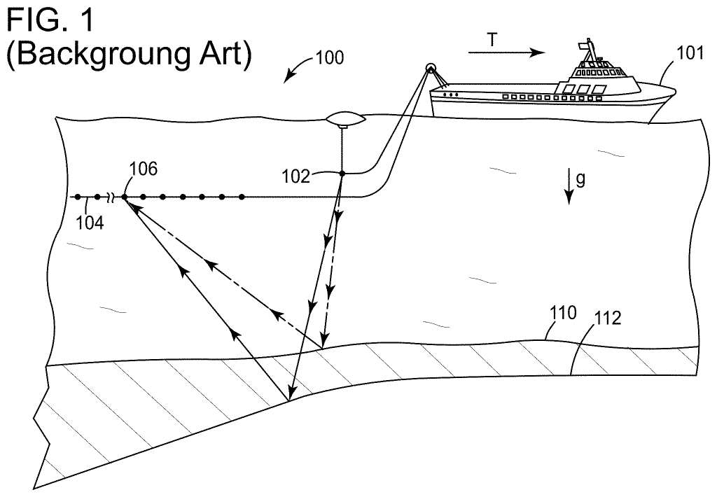

According to another embodiment, a third characteristic of a TopSeis configuration is the spread of the sources along the cross-line direction, i.e., along the direction Y, which is perpendicular to the inline direction X and the vertical direction Z. For best possible subsurface sampling, it is desired to have equally spaced (or closed to equally spaced) sources, and/or equally spaced source lines. Also, to get uniform near offset sampling it is desired to have the sources and/or source lines widely spread. The difference between source spacing and source line spacing is the following. Source spacing is defined as the distance between adjacent sources along the cross-line direction for a single crossing of the surveyed area with the acquisition system. However, a source line spacing is defined as the distance between adjacent source lines (i.e., the line that is followed by any source) for multiple crossings of the survey area. In this regard, FIGS. 3-5 show only one crossing of the survey area while FIG. 1 shows multiple crossings of the survey area.

The source separation in this embodiment is calculated according to the following formula:

srcₛₑₚ=k·(strₛₑₚ/n_{src}), (1)

where srcₛₑₚ is the source separation (e.g., 50 m), strₛₑₚ is the streamer separation (e.g., 100 m), n_{src} is the number of front or top sources, k is a natural number that is different from n·n_{src}, and n is any natural number, i.e., 1, 2, 3, 4, etc.

The solution to equation (1), from a geophysical point of view, should offer (i) a uniform spread of the sources along the cross-line direction and (ii) an interleaved binning. The binning, although known in the art, is explained herein for clarity.

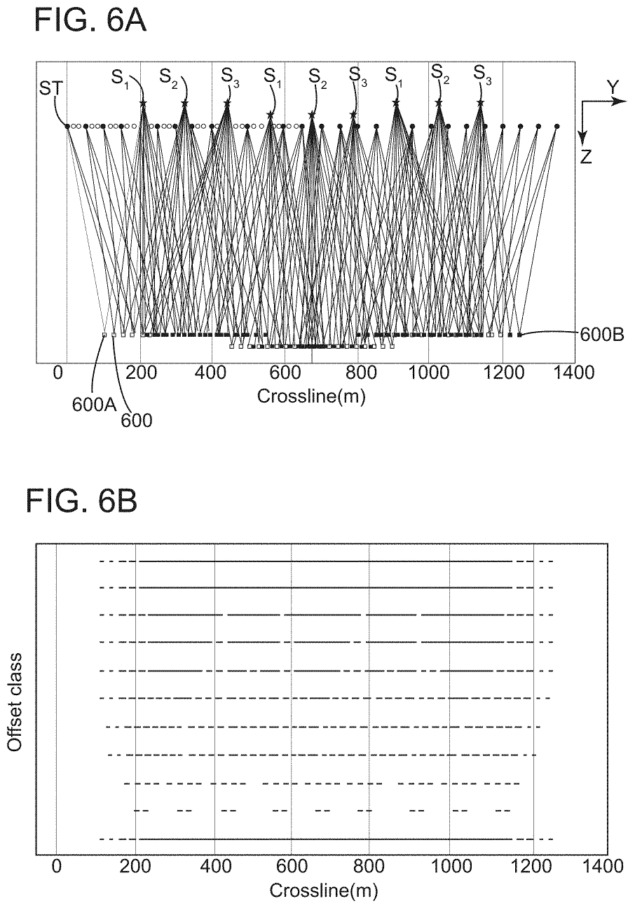

FIG. 6A shows three sources (they can be front or top sources) S1 to S3 that are towed by a vessel (not shown) along the inline direction X (entering into the page). The sources are towed first along the X direction (entering into the page), then along the opposite X direction with a certain offset (coming out of the page) and then again along the X direction (again entering the page). Thus, three source lines for each source are shown in this figure. A separation along the cross-line direction Y is selected to be 116.69 m. The streamers ST are extending along the X direction. In this embodiment there are 14 streamers at 50 m cross-line distance. A bin 600 is shown at the bottom of FIG. 6A and corresponds to those locations on the ocean bottom (or another plane selected into the earth) at which waves from a single source are reflected and all those reflected waves are recorded by a single sensor on a streamer. FIG. 6A shows plural bins, denser at the middle and less denser at the fringes of the surveyed surface. This is happening because of the plural path lines that are followed by the streamer vessel. Interleaved bins are those bins that do not overlay with each other, but most of the bins are adjacent to two other bins, except for the peripheral bins 600A and 600B. A representation of these bins 600 is shown in FIG. 6B, as a function of the offset class of each streamer. The offset class, which is the label of the Y axis in FIG. 6B, is a grouping of the offset (i.e., the distance between a given source and a given sensor). FIG. 6B plots the bins relative to offset classes with an offset span of 50 m. It is noted that the bins are sparse for low offset (i.e., for the sensors that are very close to the sources), but their density increases as the offset increases. It is noted that for classes between 250 and 300 m and upward, the bins are fully interleaved, i.e., most of the bins have two neighbors, there is no overlay with the neighbors, but the neighbors are one next to the other. For the source separation of 116.69 m and streamer separation of 50 m in this embodiment (given the fact that there are 3 sources and 14 streamers), the bin width is about 8.33 m.

Thus, equation (1) discussed above can be used for the front and/or top sources for calculating their separation subject that the bins are interleaved. However, there are mathematical solutions for equation (1) that do not achieve interleaved bins. If that is the case, an ideal source separation src_{sepideal} that gives interleaved bins is given by:

$$\begin{matrix}{k}_{ideal} = \frac{{n}_{str}}{2} , and & ( 2 ) \\ {src}_{{sep}_{ideal}} = {k}_{ideal} \cdot ( \frac{{str}_{sep}}{{n}_{src}} ) , & ( 3 )\end{matrix}$$

where k_{ideal} is a natural number that is different from n·n_{src}, n is any natural number, i.e., 1, 2, 3, 4, etc., and nₛₜᵣ is the number of streamers.
Some solution provided by equation (3) may be a solution where the bins are not-interleaved. For those cases, k_{ideal} is chosen to be

$${k}_{ideal} = \frac{{n}_{str}}{2} - 1$$

so that equidistant source lines are obtained and the bins are interleaved. For a typical acquisition setup having 10 to 16 streamers, k_{ideal} is in the range of 5 to 8.

Alternatively, the source separation characteristic for a marine seismic configuration may be calculated with the following formula:

$${src}_{sep} = {str}_{sep} \cdot [ ( floor ( \frac{m}{2} ) ) + \frac{( 2 m - 4 floor ( \frac{m}{2} ) - 1 )}{{n}_{src}} ] , \qquad ( 4 )$$

where m is one of 1, 2, 3, 4, 5, 6, 7, 8, and 9 and the floor function is defined as a function that takes as input a real number x and gives as output the greatest integer less than or equal to x. For a three source and 12 streamers having a separation of 50 m, and m=3, the source separation is 66.66 m according to equation (4). The number m is chosen in equation (4) to provide a uniform source line separation.

The source line separation of the configuration shown in FIG. 6A was calculated with equations (2) and (3), resulting in a k=7. The source line separation was calculated to be 116.66 m, which gave uniform source line spacing—and optimal near offset coverage.

Another implementation of the source line separation calculations is now discussed. By using equations (2) and (3) for a 3 source, 12 streamers with cross-line separation of 50 m, the number k is calculated to be 6, i.e., the number of streamers (12) divided by 2. However, the solution with k=6 does not produce equidistant source line separation and would not give interleaved binning. Thus, the constant k is selected to be (no_str/2)−1, i.e., k=5, which produces a source line separation of 83.35 m and a bin width of 8.33 m, which is the “best” solution under these conditions.

In another embodiment, 6 sources have been considered and 14 streamers with a separation of 75 m. With these parameters, the constant k=14/2=7, which results in the source line separation of 87.5, which is equidistant and produces interleaved bins. Note that any of the equations (1) to (4) discussed above may be used for calculating the source line separation and this is true for both the front and top sources. In other words, the equations discussed above may be used for both the front and top sources, or only for the top sources or only for the front sources.

According to another embodiment, which is illustrated in FIGS. 7A and 7B, there is an acquisition system 700 that includes a streamer vessel 702 that tows a streamer spread 704. The streamer spread 704 includes plural streamers 706, which are attached to tow lines 709, through connections 710. Two top sources 722A and 722B are positioned above the streamer spread 704, as also shown in FIG. 7B, which is side view of the acquisition system 700. Note that source vessel 720 is shown with a dash line indicating that the top sources 722A and 722B could be towed by the source vessel 720. However, the drawings also indicate that source vessel 720 is optional, in which case the top sources 722A and 722B are towed by streamer vessel 702. FIG. 7B clearly indicates that the top sources 722A and 722B are directly above the streamer spread 704, along a vertical axis Z. Also, FIG. 7B indicates that a depth of the streamers 706 relative to the water surface 701 is larger than a depth of the top sources relative to the water surface. As previously discussed, streamers 706 can be horizontal, slanted or curved.

Returning to FIG. 7A, this figure also shows the source lines 730A and 730B followed by the top sources 722A and 722B, respectively, during one survey line (or preplot line) 732. Those skilled in the art know that in order to survey a desired surface, the streamer vessel 702 follows many survey lines 732. Thus, once the streamer vessel 702 arrives at the end of the survey line 732, the vessel turns around and follows another survey line. This means that the top sources follow the source lines 730A and 730B for one survey line and then follow adjacent source lines 734A and 734B, which are offset from the initial source lines 730A and 730B. If all the source lines for a given survey area are considered, one goal of the seismic acquisition system 700 is to have the top sources follow source lines that are equidistant over the entire survey area, and the bins associated with these lines are interleaved. Although FIG. 7A does not show the source lines 730A, 730B, 734A, and 734B to be equidistant, this is because the figure is not at scale. However, cross-line source line separation distance D1 for the source lines 730A, 730B, 734A, and 734B in FIG. 7A is considered to be a constant as the streamer vessel advances along different survey lines 732.

In one application, the cross-line source line separation distance D1 for the top sources in the system 700 is calculated using equation (1). In another application, the cross-line source line separation distance D1 is calculated using equations (2) and (3). In still another application, the cross-line source line separation distance D1 is calculated using equation (4). For any of these applications, it is possible to add front sources 708A and 708B, which are towed by the streamer vessel 702. Because the presence of the front sources 708B and 708B may be optional, these sources are indicated with a dashed line in the figures.

If the system 700 includes both sets of front sources 708 and top sources 722, the cross-line source line separation distance D1 for the top sources and the cross-line source line separation distance D2 for the front sources may be calculated with equation (1), or equations (2) and (3), or equation (4). In other words, suppose that the set of top sources 722 includes no_{src1} sources and the set of front sources 708 includes no_{src2} sources. In one embodiment, no_{src1} is different from no_{src2} and D1 is different from D2. In another embodiment, no_{src1} is different from no_{src2} and D1 is calculated with any of the equations (1) to (4) and D2 is calculated with a different equation from the set of equations (1) to (4). In yet another embodiment, no_{src1} is different from no_{src2} and SPIt is different from SPIf and D1 is different from D2. In still another embodiment, no_{src1} is different from no_{src2}, SPIt is different from SPIf, and D1 is calculated with any of the equations (1) to (4) and D2 is calculated with a different equation from the set of equations (1) to (4). One skilled in the art would understand that when the top and front sets of sources are present, any of the parameters discussed above (e.g., number of sources in a set, SPI for a set, cross-line source line separation for a set) for one set may be varied relative to the other set for implementing the seismic data acquisition system 700. Also, any of these embodiments may be combined with straight, slanted or curved streamers. Further, any of the above embodiments may be implemented only with one or more streamer vessels, or one or more streamer and source vessels. Also, one skilled in the art would understand that when the SPI is different for the two sets of sources, it means that the SPIf is not a multiple or factor of the SPIt. Further, it is understood that for any of the combination noted above in terms of the number of sources, SPI factor, cross-line source line separation, the bins are interleaved.

Any of the combination noted above may be further modified so that a dithering time is added to the SPI. For example, in one embodiment, a dither is added only to the top sources. In another embodiment, the dither is added only to the front sources. In still another embodiment, the dither is added to all the sources. In yet another embodiment, in addition to the dither added to one or more sources, the SPIt is restricted to be less or equal to 12.5 m. In another embodiment, different dithers are added to the front and top sources. For example, a dither of ±300 ms is added to the top sources, while a dither of ±500 ms is added to the front sources.

Any of the embodiments discussed above may include various source elements. For example, the sources (top, front or both) may include only air guns, only vibratory sources or a mixture of two type of elements. Another modification that can be applied to any of the embodiments noted above is to have the streamer portion directly below the top sources at least 5 m deeper than the top source. Another modification for any of the above discussed embodiments is to have the front and top sources including different source elements, i.e., the front sources to include air guns having a total volume larger than 2500 cuin while the top sources have air guns having a total volume smaller than 2500 cuin. In still another modification, some of the sources are fired simultaneously or close to simultaneously. In yet another modification, the top source vessel is 2 km behind of more relative to the front buoys of the front sources, along the inline direction. In another modification, the top vessel follows the preplot line while the front vessel (streamer vessel) follows the top vessel as this strategy offers the best far-offset coverage for the front end shooting.

Regarding the original TopSeis configuration in the '005 patent application, is was noted that it is capable to acquire zero and near zero offsets that is very valuable when imaging the shallow targets. Also, because the sources behind the source vessel are spread out wide, they provide a more uniform sampling (compared to conventional acquisition) of the shot points in the cross-line direction. This configuration has been shown to give improved imaging results for reservoirs down to beyond 3 s total travel time. However, one drawback of this traditional TopSeis configuration is the lack of long offset data. Such long offset data is important for deep imaging and a basis for full waveform inversion (FWI).

One solution to this problem is to also deploy seismic sources from the streamer vessel, i.e., the front sources discussed in the previous embodiments. In this way, the streamer (front) vessel could for example be acquiring a (large) conventional exploration survey and during parts of this survey, typically over areas that have been identified as particularly interesting, a source vessel come in over the seismic streamer spread to simultaneously acquire additional high fold zero and near offset TopSeis data. In other words, the embodiments discussed above do not have to have the front and top sources present during the entire survey. In one embodiment it is possible to select certain areas of the survey for which to bring in the top sources. This combined survey of top and front sources delivers more traces compared to a traditional survey and the blending of the shots from the front and top sources can double the amount of data acquired during a given survey time.

The combined effect of a dual triple source setup (i.e., three top sources and three front sources) is that in the near to mid offset range it can be shown that around 2.25 times more traces can be obtained compared to a traditional TopSeis survey and more than 4.5 times more traces compared to a conventional (one vessel) acquisition. In this regard, it is understood in this application that “zero” and “near” offset are offsets in the range of 0 to ˜+/−500 m (in both directions because of the split spread geometry in TopSeis. A “long” offset data would typically be offsets of more than 4-5 km.). Conceptually, the novel TopSeis configuration (i.e., both front and top sources) can be seen as a dual triple source or a hexa (6) source, with a few interesting benefits that are discussed below.

The natural cross-line bin size (dy) from a seismic acquisition is given by:

$$dy = \frac{Δ y}{2 \cdot {no}_{src}} , \qquad ( 5 )$$

where Δy denotes the streamer separation in meters and no_{src} is the number of deployed sources. For example, if the streamer separation is 75 m and the number of deployed sources is 3, the cross-line bin size is 12.5 m while a 6 sources acquisition gives a cross-line bin size of 6.25 m.

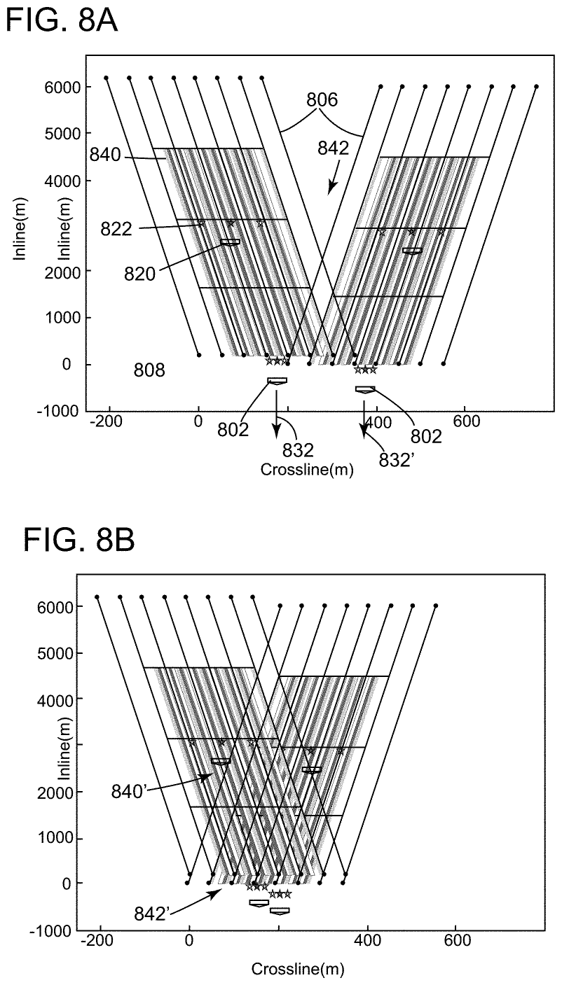

However, in a setup like the one in FIGS. 7A and 7B, natural feathering (and potentially streamer fanning) will make this more complicated, resulting in both empty and/or double fold bin-lines. This is illustrated in FIGS. 8A and 8B, where the streamers 806, front sources 808 and top sources 822, front vessel 802 and top vessel 820 positions, and also cmp coverage 840 for two neighboring sail-lines 832 and 832′ are illustrated with 2° opposing feathering (i.e., the streamers make the 2° with the sail-lines 832 and/or 832′). In FIG. 8A, the steering is designed to give a near uniform coverage for cmps 840 from the front sources 808. The cmp-coverage from the over-the streamer sources then gets a big hole at location 842. In FIG. 8B, the steering is designed to give a uniform coverage for the cmps 840′ from the over the streamer sources. However, in this case the cmps from the front sources 808 are severely overlapped at location 842′.

The net result is that in the case of feathering, the cmp positions of the front and top sources will not be perfectly interleaved. It is therefore not technically correct to assume that a dual tri-source setup will give the same natural bin size as a sexo source, when feathering is present. However, a dual tri-source setup will provide a very high trace count, which certainly is beneficial both in terms of interpolation/regularization and in terms of signal-to-noise ratio (SnR).

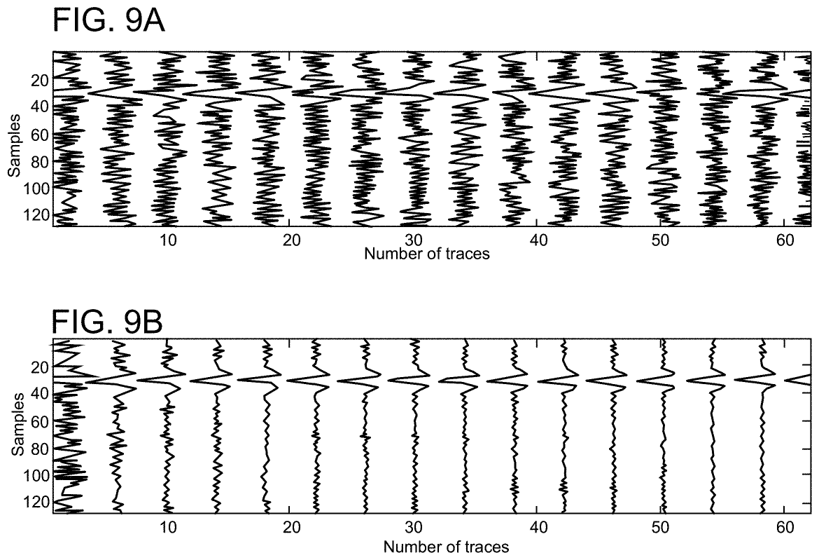

Thus, one skilled in the art would understand that it is difficult to take full advantage of the two triple sources with regards to cross-line sampling in the presence of feathering. However, the extra traces generated by this configuration, even in the presence of feathering, can be used to improve the fold, and thereby also the SnR. Assuming that the acquired signal is correlated and the noise is random, the SnR will scale with the square root of N, where N is the number of measurements (fold). FIGS. 9A and 9B illustrate this by showing the effect of stacking a synthetic trace in the presence of strong random noise. FIG. 9A shows the collected traces with a large amount of random noise while FIG. 9B shows the cumulative track of the traces from FIG. 9A, which now show a reduced amount of noise (supposing that the noise is uncorrelated).

Returning to FIG. 8B, it is noted that if a steering strategy is used whereby the aim is to steer for near-offset coverage for the top sources, the long offset data from the front sources also can be expected to be fairly uniformly distributed. This is good for any FWI (full waveform inversion) work, and is a benefit that is normally not present in conventional marine acquisition where one normally only steers for coverage on the near-offsets. Thus, in one embodiment, the top vessel sails along straight pre-plot lines while the front vessel steers such that the near-offsets are directly underneath the front vessel.

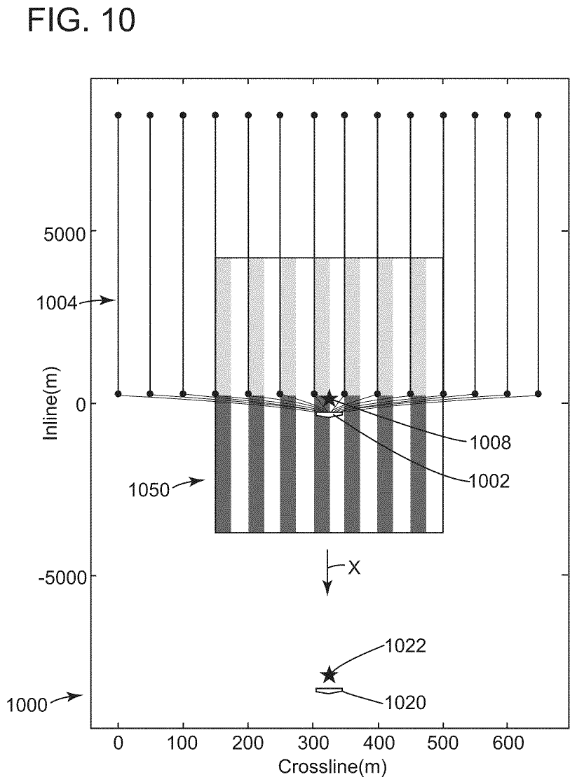

Having an extra source vessel available for a survey system 1000 (the top vessel 1022 in the novel TopSeis configuration) also opens up an opportunity to acquire super-long offset data 1050, as illustrated in FIG. 10, without the need to mobilize an extra source vessel. In this case, the top vessel 1020 could, for example, be moved forward to provide offsets in the range of 8-16 km. FIG. 10 shows the top vessel 1020 sailing ahead of the streamer vessel 1002 along the inline direction X, and thus, the top source 1022 is also ahead of the streamer spread 1004, similar to front source 1008.

In one embodiment, it is possible to steer the streamer vessel 1002 away from a platform or another obstacle. In this case, a conventional acquisition will get an illumination hole beneath the obstacle. However, by utilizing the source vessel 1020, it is possible to undershoot the obstacle by moving the source vessel 1020 from the position above the spread 1004 to a position “on the other side” of the obstacle. Thus, when an obstacle is encountered, the streamer vessel 1002 moves on one side of the obstacle while the source vessel 1020 moves on the opposite side of the obstacle for filling in the hole that normally would appear in a traditional seismic survey.

With regard to the blending and deblending methods to be used with the seismic data acquired with the system 700 shown in FIGS. 7A and 7B, it is possible to configure the seismic acquisition system 700 to have 14 streamers, separated by 75 m and each streamer having a length of, for example, 8,100 m, the top vessel (source vessel) tows 3 sources separated cross-line by 66.67 m (calculated with one of the equations (1) to (4)), SPIt=8.33 m and a dither of +/−200 ms, and the volume of the top sources is ˜1725 cuin, while the front vessel (streamer vessel) tows 3 sources separated by 33.33 m, SPIf=12.5 m and a dither of +/−500 ms, and the volume of the front sources is about ˜4200 cuin.

The specific configuration (distances and dithers) discussed in the previous paragraph with regard to the configuration shown in FIG. 7A, uses dithering times. It is beneficial to introduce source time dithering in order to separate energy from overlapping sources. When properly sorted and aligned, this will effectively randomize the arrival time of the other source(s), turning the blending problem into a random noise problem, which is much easier to tackle. To further spread out the arrival time of the energy from the various sources, it may also be advantageous to adjust the SPI of one of the vessels by a fixed ΔT to avoid SPI that are exact multiples of each other. With a dual triple source setup, some typical acquisition parameters are those provided in the previous paragraph.

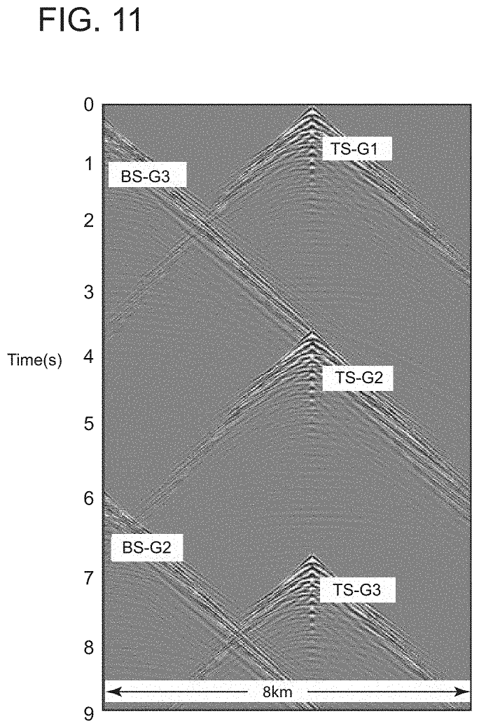

A numerically blended shot gather from such an acquisition is shown in FIG. 11, where it can be observed that the reflection energy from the front (BS gun 1 and 2) and top (TS gun 1, 2 and 3) sources have significant differences in move-out, and partly populate different parts of the t-x gather.

In the first deblending step, it is desired to separate the shots coming from the two different vessels. A number of tools are available to do this, see, for example, Rohnke and Poole (2016), (Simultaneous Source Separation Using an Annihilation Filter Approach, 78th EAGE Conference and Exhibition 2016, DOI: 10.3997/2214-4609.201600953 and U.S. Pat. Nos. 9,348,051 and/or 9,551,800) and the references therein. In this embodiment, an adaptation of a seismic interference denoising workflow described in Zhang et al. (2015) (Seismic interference noise attenuation based on sparse inversion. SEG Technical Program Expanded Abstracts 2015: pp. 4662-4666 and U.S. Pat. No. 9,651,697) has been used. The idea is to run a progressive sparse 2D Tau-P inversion applied in local spatial windows. Implicitly, this takes advantage of both differences in move-out, and arrival time of the blended shots to achieve nearly perfect deblending.

Once the data from the two vessels are separated, it is possible to again take advantage of the source dithered to perform a second deblending step, to extend the usable record length of the data (see, for example, Maraschini et al. (2016), Rank-reduction deblending for record length extension: The example of the Carnarvon basin. SEG Technical Program Expanded Abstracts 2016: pp. 4628-4632. DOI: 10.1190/segam2016-13685251.1). In this way, the SPI and vessel speed is no longer constraining and individual shots with extended record lengths can be recovered via deblending in the data-processing stage. This may be valuable for the data from the vessel sitting over the streamer where only about ˜3 s of clean data is recorded.

In the above embodiments, it has been shown that it is practically possible to simultaneously acquire high-density both zero- and long-offset data using front and top sources. By dithering the shot times and taking advantage of the move-out differences of the data from individual source excitations, accurate and effective source deblending can be achieved.

If un-synchronized shot-point intervals on the front and top sources are selected, even better (nearly perfect) deblending was achieved. However, this comes at a cost of having to regularize the data at some point during data processing. With the embodiments discussed above, it is also possible to use the source dithering to extend the practical record length of the data. This is valuable, especially in a triple or hexa source setting, where the “clean” record length is limited.

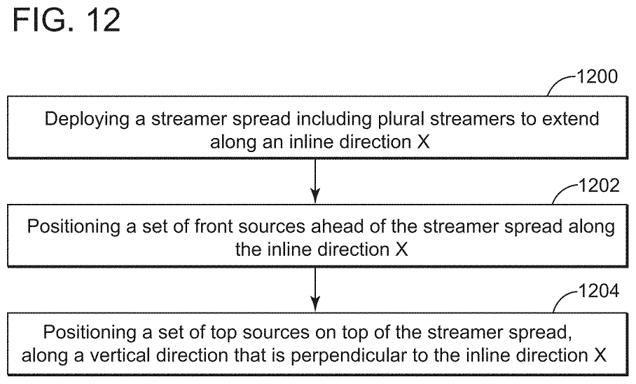

Based on the above embodiments, the various elements of a seismic acquisition system may be arranged to take advantage of the deblending capabilities. Thus, according to an embodiment illustrated in FIG. 12, there is a method for determining positions of various components of a seismic survey system. The method includes a step 1200 of deploying a streamer spread 704 (see FIG. 7A) including plural streamers 706 to extend along an inline direction X; a step 1202 of positioning a set of front sources 708 ahead of the streamer spread 704 along the inline direction X; and a step 1204 of positioning a set of top sources 722 on top of the streamer spread 704, along a vertical direction that is perpendicular to the inline direction X. A characteristic of the set of front sources 708 is different from a characteristic of the set of top sources 722, and bins corresponding to collected seismic data are interleaved.

The disclosed embodiments provide a seismic acquisition system that has two sets of sources, one above the streamer spread and one ahead of the streamer spread. The two source sets have at least one characteristic that is different and the bins of the acquired seismic data are interleaved. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a general-purpose computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A seismic data acquisition system comprising:
a streamer spread including plural streamers that extend along an inline direction X;
a set of front sources that are positioned ahead of the streamer spread along the inline direction X; and
a set of top sources that are positioned on top of the streamer spread, along a horizontal direction that is perpendicular to the inline direction X,
wherein a characteristic of the set of front sources is different from a characteristic of the set of top sources, and
wherein bins corresponding to collected seismic data from each source set are interleaved.

2. The system of claim 1, wherein the characteristic is a number of sources in each set.

3. The system of claim 1, wherein the characteristic is a shot point interval for the sources in each set.

4. The system of claim 3, wherein the shot point interval for at least one of the sets is dithered.

5. The system of claim 1, wherein the characteristic is a number of sources and a shot point interval in each set.

6. The system of claim 1, wherein the characteristic is a cross-line source separation for each set.

7. The system of claim 6, wherein the cross-line source separation srcₛₑₚ for the set of top sources or the set of front sources is calculated as:
srcₛₑₚ=k·(strₛₑₚ/n_{src}),
where strₛₑₚ is the streamer separation in the streamer spread, n_{src} is the number of top or front sources, k is a natural number larger than 2 and different from n·n_{src}, and n is any natural number.

8. The system of claim 6, wherein the cross-line source separation srcₛₑₚ for the set of top sources or the set of front sources is calculated as:
$${k}_{ideal} = \frac{{n}_{str}}{2} or {k}_{ideal} = \frac{{n}_{str}}{2} - 1 , and {src}_{{sep}_{ideal}} = {k}_{ideal} \cdot ( \frac{{str}_{sep}}{{n}_{src}} ) ,$$
where k_{ideal} is a natural number that is different from n·n_{src}, n is any natural number, strₛₑₚ is the streamer separation in the streamer spread, and nₛₜᵣ is the number of streamers in the streamer spread.

9. The system of claim 6, wherein the cross-line source separation srcₛₑₚ for the set of top sources or the set of front sources is calculated as:
$${src}_{sep} = {str}_{sep} \cdot [ ( floor ( \frac{m}{2} ) ) + \frac{( 2 m - 4 floor ( \frac{m}{2} ) - 1 )}{{n}_{src}} ] ,$$
where strₛₑₚ is the streamer separation in the streamer spread, nₛₜᵣ is the number of streamers in the streamer spread, m is a natural number larger than 2, and the floor function is defined as a function that takes as input a real number x and gives as output the greatest integer less than or equal to x.

10. The system of claim 1, wherein the characteristic includes (1) a number of sources, (2) a shot point interval, and (3) a cross-line source line separation in each set.

11. The system of claim 1, wherein parts of the streamer spread which lie directly below the set of top sources has a depth of at least 20 m.

12. The system of claim 1, wherein the streamers are curved relative to the water surface.

13. A method for determining positions of various components of a seismic survey system, the method comprising:
deploying a streamer spread including plural streamers to extend along an inline direction X;
positioning a set of front sources ahead of the streamer spread along the inline direction X; and
positioning a set of top sources on top of the streamer spread, along a horizontal direction that is perpendicular to the inline direction X,
wherein a characteristic of the set of front sources is different from a characteristic of the set of top sources, and
wherein bins corresponding to collected seismic data from each source set are interleaved.

14. The method of claim 13, wherein the characteristic is a number of sources in each set.

15. The method of claim 13, wherein the characteristic is a shot point interval for the sources in each set.

16. The method of claim 15, wherein the shot point interval for at least one of the sets is dithered.

17. The method of claim 13, wherein the characteristic is a number of sources and a shot point interval in each set.

18. The method of claim 13, wherein the characteristic is a cross-line source separation for each set.

19. The method of claim 18, wherein the cross-line source line separation srcₛₑₚ for the set of top sources or the set of front sources is calculated as:
srcₛₑₚ=k·(strₛₑₚ/n_{src}),
where strₛₑₚ is the streamer separation in the streamer spread, n_{src} is the number of top or front sources, k is a natural number larger than 2 and different from n·n_{src}, and n is any natural number.

20. The method of claim 18, wherein the cross-line source line separation srcₛₑₚ for the set of top sources or the set of front sources is calculated as:
$${k}_{ideal} = \frac{{n}_{str}}{2} or {k}_{ideal} = \frac{{n}_{str}}{2} - 1 , and {src}_{{sep}_{ideal}} = {k}_{ideal} \cdot ( \frac{{str}_{sep}}{{n}_{src}} ) ,$$
where k_{ideal} is a natural number that is different from n·n_{src}, n is any natural number, strₛₑₚ is the streamer separation in the streamer spread, and nₛₜᵣ is the number of streamers in the streamer spread.

21. The method of claim 18, wherein the cross-line source line separation srcₛₑₚ for the set of top sources or the set of front sources is calculated as:
$${src}_{sep} = {str}_{sep} \cdot [ ( floor ( \frac{m}{2} ) ) + \frac{( 2 m - 4 floor ( \frac{m}{2} ) - 1 )}{{n}_{src}} ] ,$$
where strₛₑₚ is the streamer separation in the streamer spread, nₛₜᵣ is the number of streamers in the streamer spread, m is a natural number larger than 2, and the floor function is defined as a function that takes as input a real number x and gives as output the greatest integer less than or equal to x.

22. The method of claim 13, further comprising:
steering the set of top vessels along straight pre-plot lines; and
steering the set of front vessels such that the near offsets are directly underneath the set of the front vessels.
